(19) United States
(12) Patent Application Publication
(10) Pub. No.: US 2016/0078180 A1
(43) Pub. Date: Mar. 17, 2016

(54) CONGREGATE CARE ACTIVITY TRACKER

(71) Applicant: Stackpole & Associates, Inc., Newport, RI (US)

(72) Inventors: Irving STACKPOLE, Newport, RI (US); Richard ASHODIAN, Boston, MA (US)

(73) Assignee: Stackpole & Associates, Inc., Newport, RI (US)

(21) Appl. No.: 14/854,991

(22) Filed: Sep. 15, 2015

Related U.S. Application Data
(60) Provisional application No. 62/050,480, filed on Sep. 15, 2014.

(51) Int. Cl. G06F 19/00; G06Q 10/06

(52) U.S. Cl. CPC G06F 19/327; G06Q 10/06398

(57) ABSTRACT

Described herein are an apparatus and a corresponding method for monitoring and evaluating personnel (staff member) in a congregate care or medical facility. The apparatus includes circuitry that is configured to assign a task to a staff member and compute a time delay incurred by the staff member in commencing the task. The circuitry authenticates the staff member and monitors a location of the staff member and a patient assisted by the staff member, to determine a displacement of the location of the staff member with respect to the location of the patient. The circuitry updates an overall score of the staff member based on the computed time delay, the determined displacement being above a first threshold, and a number of times the staff member is reported, and further recommends a type of training session for the staff member based on the overall score being lower than a predetermined score threshold.

### INCORPORATION BY REFERENCE

This disclosure claims the benefit of U.S. Provisional Application No. 62/050,480, filed on Sep. 15, 2014, the disclosure of which is incorporated herein by reference in its entirety.

### FIELD OF INVENTION

The present disclosure relates generally to the field of healthcare and behavioral health monitoring. Specifically, aspects of the present disclosure relate to an apparatus and method thereof for monitoring and evaluating the activities of nursing and residential care and supervision provided to residents and patients in a medical or congregate care facility.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Congregate care is a form of nursing and/or residential care for people who require or desire some form of residential support, supervision or nursing care. In certain instances, congregate care facilities such as skilled nursing facilities, intermediate care facilities, and long term acute care hospitals and the like are licensed by the state and regulated by both federal and state authorities. In such facilities patients require extensive nursing supervision and/or direct professional care.

In other types of congregate care facilities such as assisted living residences and independent living residences, the residents live more independently and require supervision for medical management, activities of daily living, and some other shared social support services such as help with instrumental activities of daily living.

A recent study has revealed that nearly 2.5 million individuals (patients) reside in approximately 35,000 congregate facilities. The congregate care facilities are operated by nearly 4 million paid staff members. A major cost expense incurred by the congregate care facilities is that of labor. For instance, 60-70% of the operating budgets of such congregate care facilities are allocated for labor (staff members).

However, currently there does not exists a mechanism of monitoring and/or evaluating the staff members in such congregate care facilities, in order to measure their behaviors within the congregate care facilities, or to ensure that the tasks assigned to the staff members are being performed in a timely and efficient manner. Thus, present day congregate facilities do not have a mechanism to ensure whether the huge labor expenses incurred are justified. Accordingly, there is a requirement for a technique of evaluating the efficiency and productivity of staff members in such facilities and moreover managing the staff members in an effective manner.

### SUMMARY

An aspect of the present disclosure provides for a device. The device comprises circuitry configured to assign a task to a staff member, compute a time delay incurred by the staff member in commencing the task, authenticate the staff member, monitor a location of the staff member and a patient assisted by the staff member, to determine a displacement of the location of the staff member with respect to the location of the patient, update an overall score of the staff member based on at least one of the computed time delay, the displacement of the location of the staff member with respect to the location of the patient being above a first threshold, and a number of times the staff member is reported. The circuitry is further configured to recommend a type of training session for the staff member based on the overall score being lower than a predetermined score threshold.

According to another aspect of the present disclosure is provided a transitory or mobile device, which can be carried by, worn by or attached to staff members and/or patients. This transitory device comprises circuitry configured to integrate with, and be responsive to other non-transitory devices and computers within the system, which mobile device transmits the location of, time delays, displacements of the location of the individual or objects to which the transitory device is fixed, allowing an update of activities and/or behaviors of the staff for patients via relayed signals to the non-transitory devices and computers within the system.

According to one aspect of the present disclosure is provided a method of monitoring and evaluating a staff member. The method comprises the steps of: assigning a task to the staff member; computing a time delay incurred by the staff member in commencing the task; authenticating the staff member; monitoring a location of the staff member and a patient assisted by the staff member, to determine a displacement of the location of the staff member with respect to the location of the patient; updating an overall score of the staff member based on at least one of the computed time delay, the displacement of the location of the staff member with respect to the location of the patient being above a first threshold, and a number of times the staff member is reported; and recommending a type of training session for the staff member based on the overall score being lower than a predetermined score threshold.

According to another aspect of the present disclosure is provided a non-transitory computer readable medium having stored thereon a program that when executed by a computer causes the computer to execute a method of monitoring and evaluating a staff member. The method comprises the steps of: assigning a task to the staff member; computing a time delay incurred by the staff member in commencing the task; authenticating the staff member; monitoring a location of the staff member and a patient assisted by the staff member, to determine a displacement of the location of the staff member with respect to the location of the patient; updating an overall score of the staff member based on at least one of the computed time delay, the displacement of the location of the staff member with respect to the location of the patient being above a first threshold, and a number of times the staff member is reported; and recommending a type of training session for the staff member based on the overall score being lower than a predetermined score threshold.

### BRIEF DESCRIPTION OF THE DRAWINGS

Various embodiments of this disclosure that are provided as examples will be described in detail with reference to the following figures, wherein like numerals reference like elements, wherein:

FIG. 1A depicts an exemplary congregate care facility monitoring system according to one embodiment;

FIG. 1B depicts an exemplary spaghetti diagram illustrating the paths traversed by staff members;

FIG. 1C depicts according to another embodiment, an exemplary congregate care facility monitoring system;

FIG. 2 illustrates schematically an exemplary mobile phone terminal device;

FIG. 3 depicts an exemplary wrist band worn by a patient;

FIG. 4 illustrates an exemplary patient chart;

FIG. 5 illustrates an exemplary staff member report;

FIG. 6A depicts according to one embodiment, a table outlining the patient type, and

FIG. 6B depicts a table outlining the types of activities performed by the staff member;

FIG. 7 depicts according to one embodiment a layout of a medical facility;

FIG. 8 depicts an exemplary portion of the layout of the medical facility;

FIG. 9 illustrates an exemplary server monitoring scenario;

FIG. 10 depicts an exemplary flowchart outlining the steps performed by the server according to one embodiment; and

FIG. 11 illustrates a block diagram of a computing device according to one embodiment.

### DETAILED DESCRIPTION OF EMBODIMENTS

Exemplary embodiments are illustrated in the referenced figures of the drawings. It is intended that the embodiments and figures disclosed herein are to be considered illustrative rather than restrictive. No limitation on the scope of the technology and of the claims that follow is to be imputed to the examples shown in the drawings and discussed herein.

The embodiments are mainly described in terms of particular processes and systems provided in particular implementations. However, the processes and systems will operate effectively in other implementations. Phrases such as “an embodiment”, “one embodiment” and “another embodiment” may refer to the same or different embodiments. The embodiments will be described with respect to methods and compositions having certain components. However, the methods and compositions may include more or less components than those shown, and variations in the arrangement and type of the components may be made without departing from the scope of the present disclosure.

The exemplary embodiments are described in the context of methods having certain steps. However, the methods and compositions operate effectively with additional steps and steps in different orders that are not inconsistent with the exemplary embodiments. Thus, the present disclosure is not intended to be limited to the embodiments shown, but is to be accorded the widest scope consistent with the principles and features described herein and as limited only by appended claims.

Furthermore, where a range of values is provided, it is to be understood that each intervening value between an upper and lower limit of the range—and any other stated or intervening value in that stated range is encompassed within the disclosure. Where the stated range includes upper and lower limits, ranges excluding either of those limits are also included. Unless expressly stated, the terms used herein are intended to have the plain and ordinary meaning as understood by those of ordinary skill in the art. The following definitions are intended to aid the reader in understanding the present disclosure, but are not intended to vary or otherwise limit the meaning of such terms unless specifically indicated.

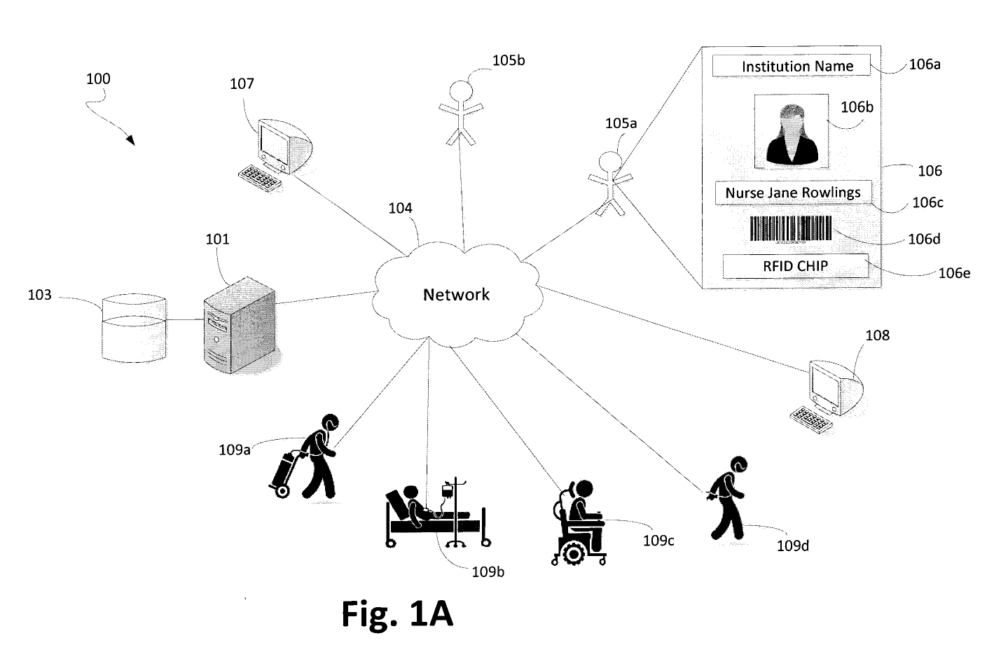

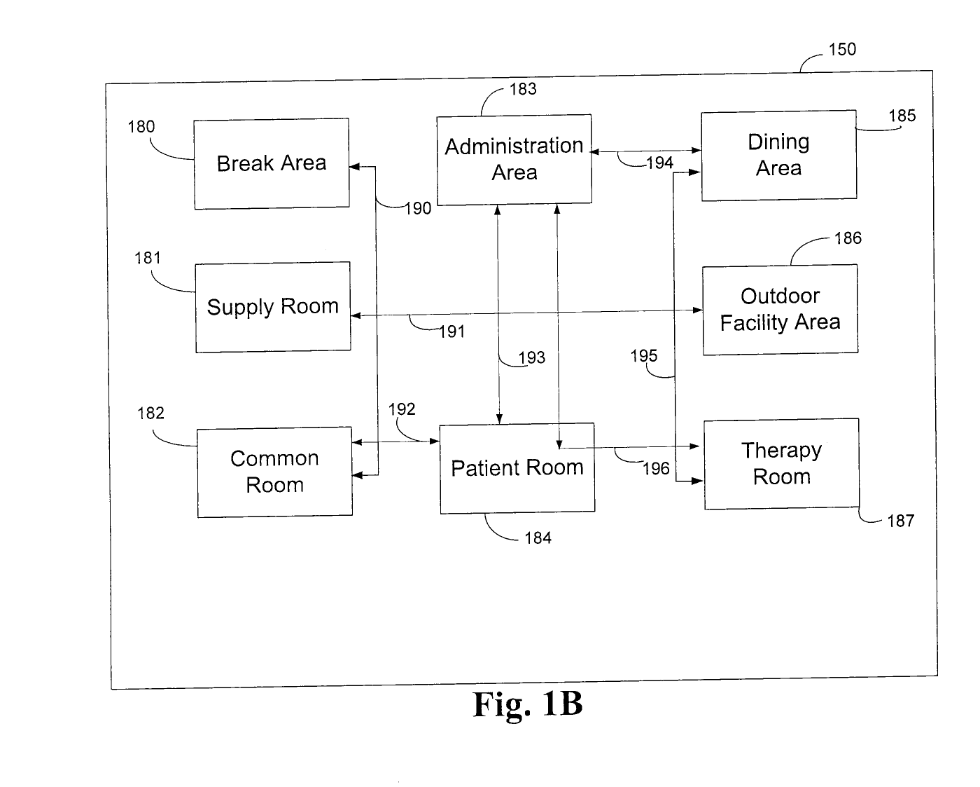

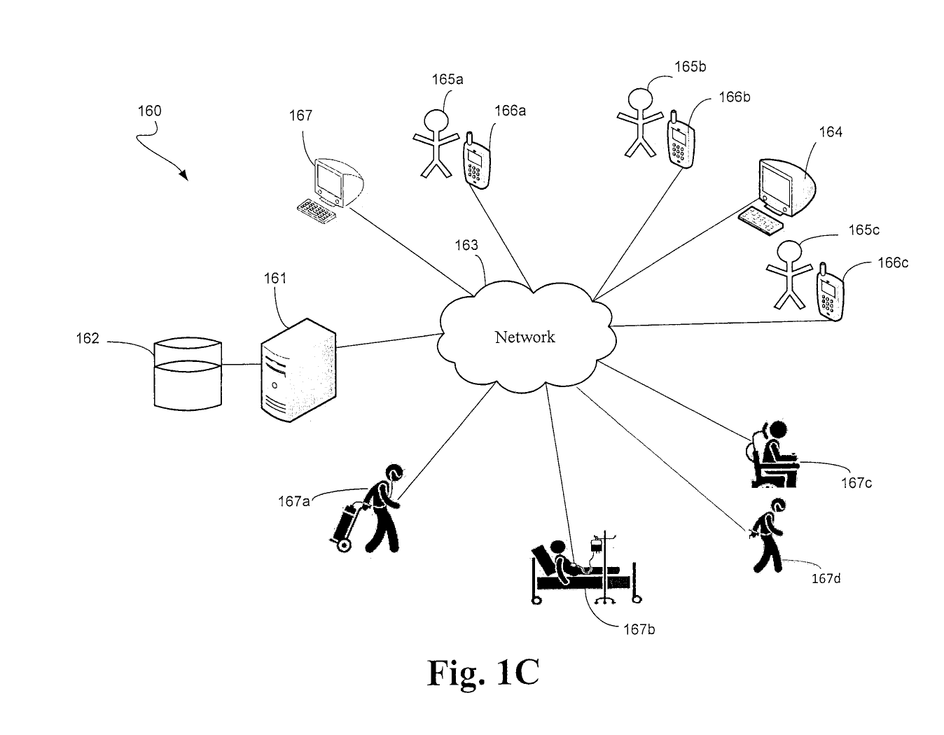

Turning to FIG. 1A, is depicted an exemplary congregate care facility system 100. The system 100 monitors patient care provided by health care professionals (i.e., staff members such as personal care assistants and nurses) according to an embodiment.

In the illustrated embodiment, the system 100 includes a communicating device (server) 101 coupled to memory 103. The communicating device 101 may be a computer, a computer system resident in a facility, a plurality of servers that are coupled to the memory 103, or may alternatively be, or be supplemented by, one or more remote computer systems via so-called “cloud” architecture. In any case, memory 103 has stored therein a process in the form of one or more sets of instructions that is/are executable by the communicating device 101 to control and manage patient care monitoring, staff behaviors, and inspection-related data. The communicating device 101 is configured in a fashion such that the device is enabled to share information with other systems and/or devices via the World Wide Web (WWW), Internet, or any other type of network 104. For the sake of simplicity, the communicating device 101 is referred to as a server 101, health and personal care professionals that assist patients are referred to as staff members in the remainder of the disclosure. Also, for the sake of simplicity, individuals resident in congregate care facilities, whether patients in nursing homes, rehabilitation centers, long-term care hospitals or residents in assisted living, independent living, or other congregate settings are referred to as patients in the remainder of this disclosure.

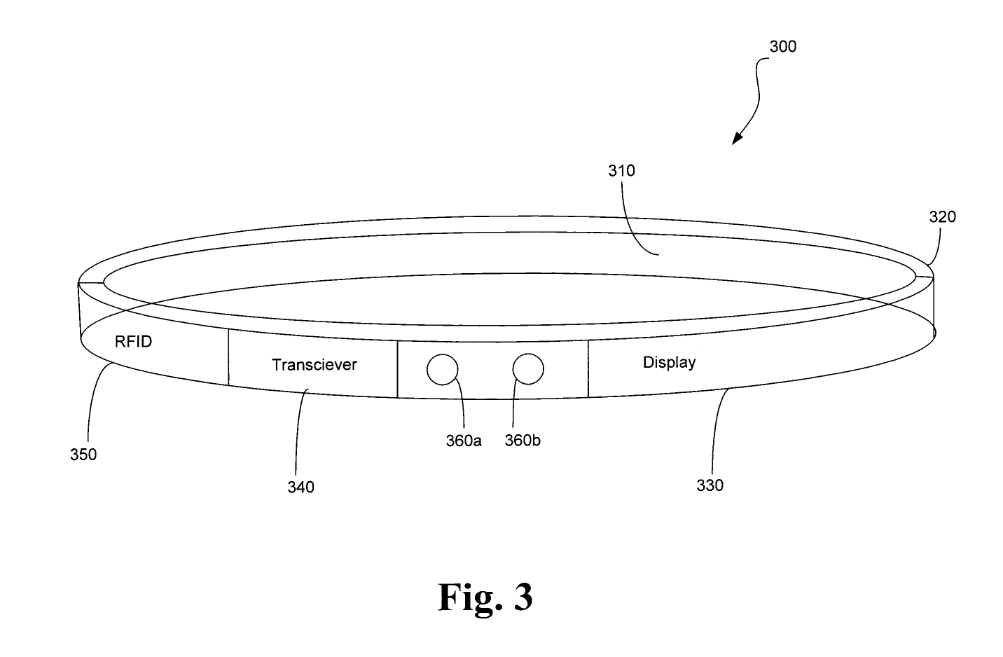

The system 100 further includes a gateway 107 via which patients' 109a-109d and staff members' 105a-105b respectively, of the congregate care facility may securely access the service provider website controlled and managed by the server 101. Approved users may access the gateway 107 via the network 104 using, for example, a desktop, laptop, notebook, tablet or other computer and/or via a portable or handheld electronic communication device that is configured to access the network 104. For instance, in the present embodiment, staff members' 105a and 105b may be equipped with a mobile device 106a in the form of a badge by which the staff members communicate with the server 101 and receive instructions pertaining to their daily duties. Note, that for the sake of illustration, only the badge 106 of staff member 105a is depicted. It must be appreciated that staff member 105b is also equipped with a similar badge or an equivalent mobile device (described later) by which the staff member can communicate with the server 101. Similarly, the patients' 109a-109c may be equipped with a corresponding mobile device and/or alternatively be equipped with a badge, wristband or other wearable or portable device (described later with reference to FIG. 3) by which the patients can communicate with the server 101.

The memory 103 has stored therein one or more sets of instructions executable by the server 101 to control and manage the service provider website wherein, the service provider website is configured to allow authenticated users to access, view, and obtain reports on inspections, staff performance evaluations and account information via the gateway 107. Furthermore, although the gateway 107 in FIG. 1 is depicted to be a separate entity from the server 101, the operation and functionality of the gateway 107 may be incorporated within the server 101.

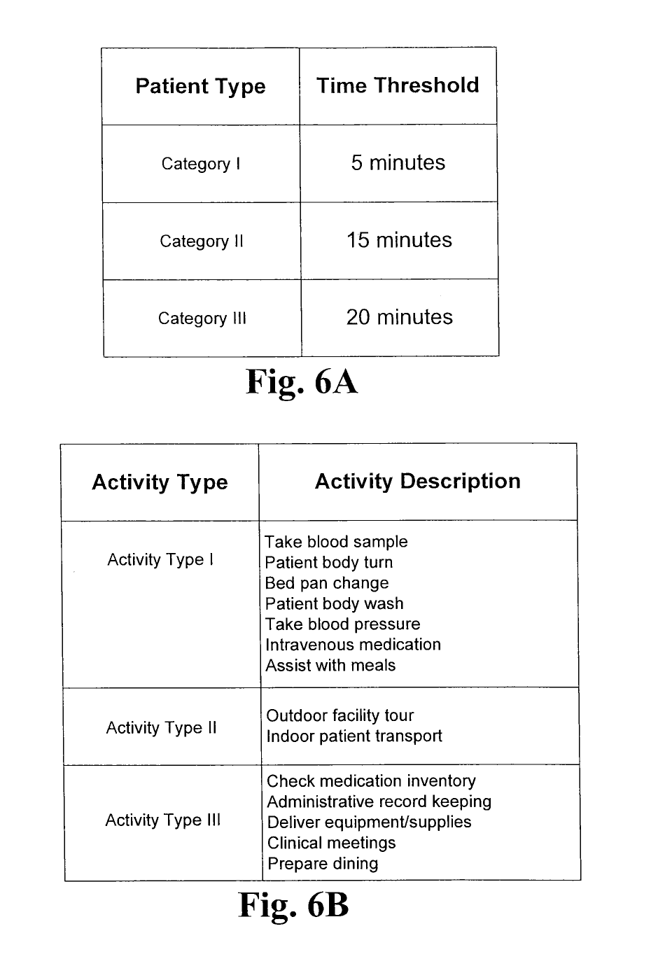

As shown in FIG. 1A, the congregate care facility may include patients of different types. For instance, patient 109a may be an ambulatory patient who suffers from a medical condition such as asthma and is therefore equipped with an oxygen tank, whereas patient 109b may be a patient who has undergone a more complicated medical procedure and is therefore bed-ridden. Accordingly, patient 109c may be a patient who is equipped with a wheelchair, whereas patient 109d may be completely mobile (due to minor medical complications). Note that while patient types such as patient 109c and 109d may be mobile and not require continuous supervision, patient 109b who is bed-ridden may require constant supervision. Specifically, the patient activities that are to be performed by staff members 105a and 105b may vary based on the type of patient. Details regarding the activities and the type of patients are described later with reference to FIGS. 6A and 6B.

The server 101 monitors the supervision provided to the patients by the staff members, and further evaluates a performance score for each staff member based on the data obtained from the supervision. The server may also incorporate an inspection process in order to authenticate whether a particular staff member assigned to perform a task for a particular patient, is in fact performing or has performed the task. In doing so, the server 101 monitors the staff members to determine the occurrence of a potential fraudulent activity. Details pertaining to the monitoring and evaluation of the staff members 105a and 105b performed by the server 101 are described later with reference to FIG. 6 to FIG. 10.

By one embodiment, the portable mobile device 106 carried by the staff members is an RFID badge. The RFID badge 106 includes the name of the congregate care facility 106a, an image of the staff member 106b, credentials of the staff member 106c, a barcode 106d that is unique to each badge 106 and enables tracking and identification of the staff member, and an RFID chip 106e that enables the staff member to communicate with the server 101.

The RFID badge 106 may be passive, active or battery-assisted passive. An active tag includes an on-board battery and periodically transmits its ID signal. A battery-assisted passive (BAP) tag has a small battery on board and is activated when in the presence of an RFID reader. It must be appreciated that a passive tag is cheaper and smaller because it has no battery and instead uses the radio energy transmitted by the reader.

Furthermore, the RFID badge 106 include at least an integrated circuit for storing and processing information, modulating and demodulating a radio-frequency (RF) signal, collecting DC power from the incident reader signal, and other specialized functions. The RFID badge may further include an antenna for receiving and transmitting signals. The badge information is stored in a non-volatile memory. The RFID chip 106e further includes either fixed or programmable logic for processing the transmission and sensor data, respectively.

By one embodiment, the congregate care facility 100 includes a plurality of RFID readers (scanners) that are disposed in different locations such as corridors (hallways), rooms, doorways and the like. The readers communicate with the RFID badges and detect the movement of the staff members. For instance, the RFID readers may transmit an encoded radio signal to interrogate the RFID badge 106. The RFID badge 106 upon receiving the message (from the reader), responds with its identification and other information. Note that since the RFID badges have individual serial numbers (e.g., barcodes), the RFID system 100 can discriminate among several badges that might be within the range of the RFID reader and read them simultaneously.

Furthermore, the various RFID readers disposed in the congregate care facility 100 may communicate with the server 101 using wireless communication, Bluetooth techniques and the like, to report the information obtained from the staff member badges. According to one embodiment, the server monitors the movement of the staff members and is configured to generate a spaghetti diagram illustrating the movement of the staff members. Specifically, as shown in FIG. 1B, the server tracks the movement (obtained via RFID badges) and generates a map illustrating the movements of the staff members.

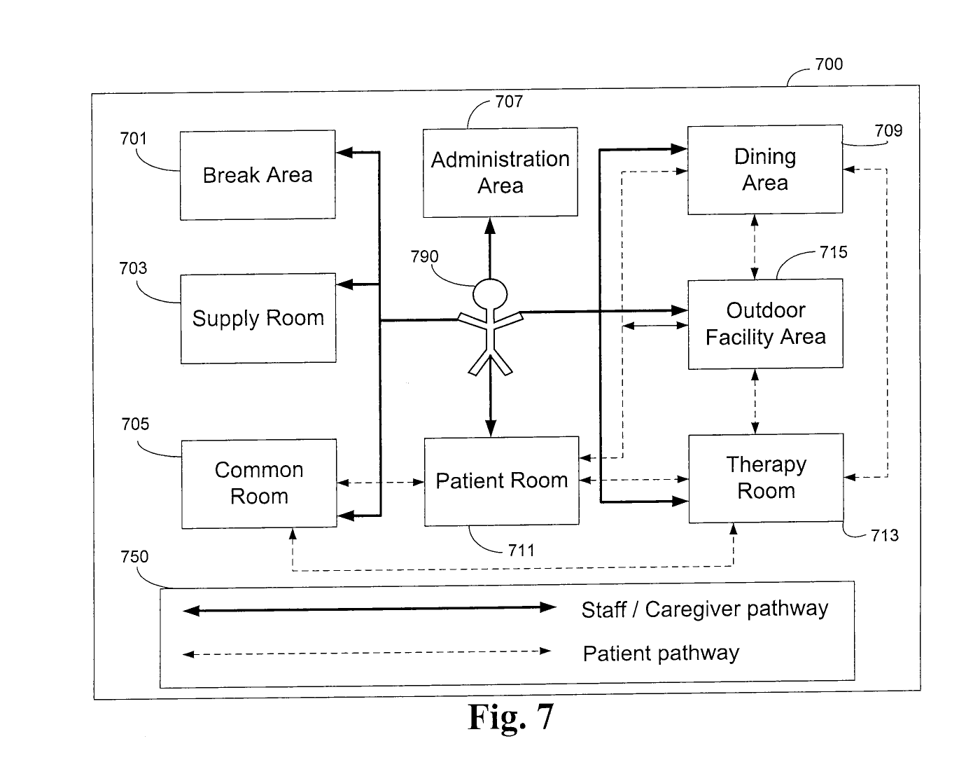

FIG. 1B depicts according to one embodiment, a spaghetti drawing 150 of a congregate care facility. The congregate care facility as depicted in FIG. 1B includes a break area room 180, a medical supply room 181, a common room 182, an administration area 183, a dining area 185, a patient room 184, a therapy room 187, and an outdoor facility area 186. Further, each of the above areas may be interconnected by corridors and/or separated from each other by walls. Furthermore, the spaghetti drawing 150 depicts the trajectories 190-196 corresponding to seven different staff members. It must be appreciated that the server 101 may also be configured to generate the trajectories of the patients who may be equipped with similar badges as badge 106 depicted in FIG. 1A. Thus, the server may monitor the movements of the patients and generate an alarm if a patient is detected to be in (or approaching) a restricted area (described later with reference to FIG. 7).

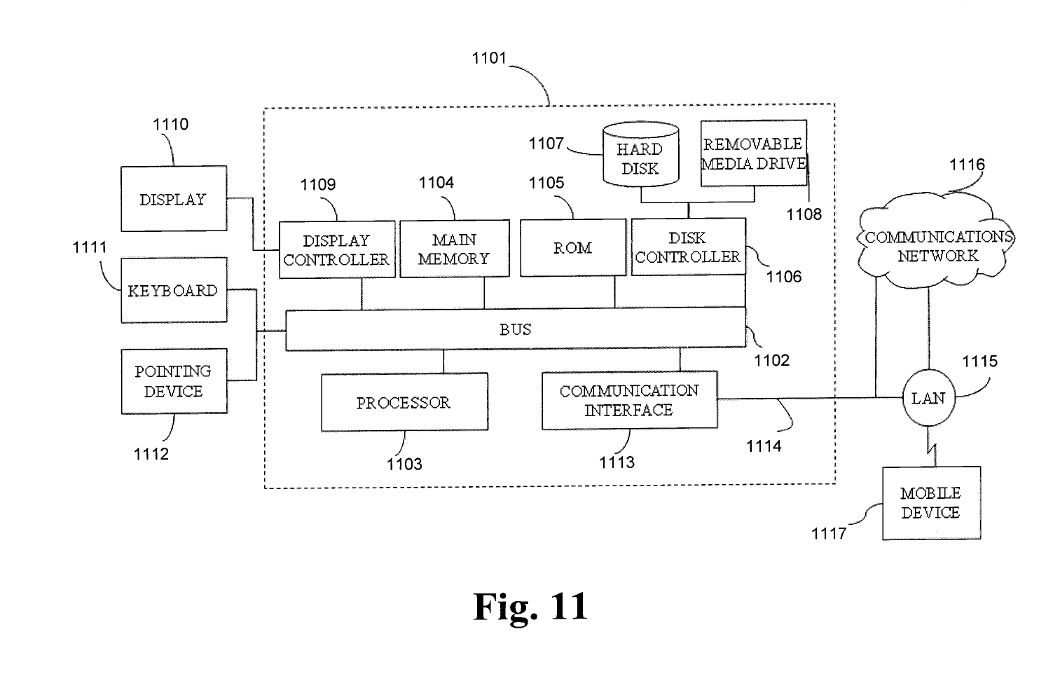

The system 100 as depicted in FIG. 1A may further include a workstation 108, wherein a staff member may perform a log-in operation (e.g., by scanning the barcode on the staff member's badge 106) and view reports of a particular patient, view daily activities to be performed for different patients, view staff evaluation report and the like. Furthermore, each of the devices 101, 107, 106, and 108 may include the configuration as shown in FIG. 11.

FIG. 1C depicts according to another embodiment, an exemplary congregate care facility monitoring system 160. The system 160 includes a server 161 coupled to a memory 162. Similar to the system as depicted in FIG. 1A, the system 160 includes a gateway 167 via which patients' 167a-167d and staff members' 165a-165c respectively, of the congregate care facility may securely access the service provider website controlled and managed by the server 101.

By one embodiment, the staff members' 165a-165c are equipped with portable mobile devices 166a-166c to share the collected monitoring data with the server 161 via the network 163. The mobile devices 166a-166c may include Global Positioning Satellite (GPS) transceivers and software configured to communicate GPS radio signals that are processed by the server 161. Accordingly, the server 161 may monitor the locations of the staff members based on the received GPS signals. The mobile devices may also be configured to determine global coordinates, e.g., latitude, longitude and altitude, as well as real time information and transmit such information to the server 161. Each of the mobile devices 166a-166c may include a processor and sufficient memory having stored therein one or more sets of instructions, e.g., in the form of a user application or app, executable by the processor to guide the staff member through a daily activity regimen.

Examples of mobile devices 166a-166c that may be used with the system 160 include, but are not be limited to, smart phones, personal communication devices (PDAs), application-specific mobile electronic devices and/or other mobile electronic devices having sufficient memory and computing power to execute a set of instructions that guide staff members through a particular assigned task, and configured to pass collected monitoring data to the server 161 via the network 163. Note that “mobile devices 166a-166c” and “mobile device 166” may be used interchangeably throughout the present disclosure.

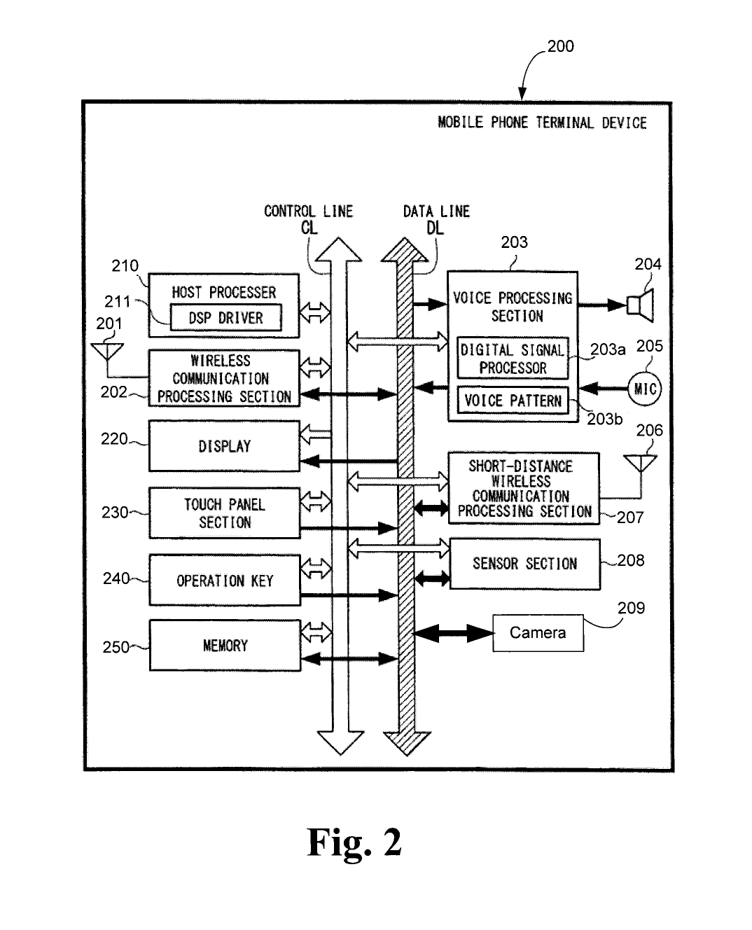

Furthermore, the mobile devices 166 may each also include a camera that is configured to take standstill (images) as well as moving pictures (video) of an activity being performed and transmit the captured video and image data to the server 161, via a transmitter. Each mobile device 166 may also be configured to time-stamp the captured images and/or videos, as well as any other data, by using a built-in timer. Specific hardware capabilities and the functionalities of the mobile device 166 are described next with reference to FIG. 2. The system 160 may further include a workstation 164, wherein a staff member may perform a log-in operation and view reports of a particular patient, view daily activities to be performed for different patients, view staff evaluation report and the like. Furthermore, each of the devices 161, 164, 166, and 167 may include the configuration as shown in FIG. 11.

It must be appreciated that the features of the above described embodiments are in no way restricted to the specific hardware components used by the staff members and/or patients. Specifically, the staff members and patients of the congregate care facility may use the RFID badges, mobile devices, and wristbands (described later with reference to FIG. 3) interchangeably in a manner that facilitates the server of the congregate care facility to monitor and track the movements of the staff members as well as patients.

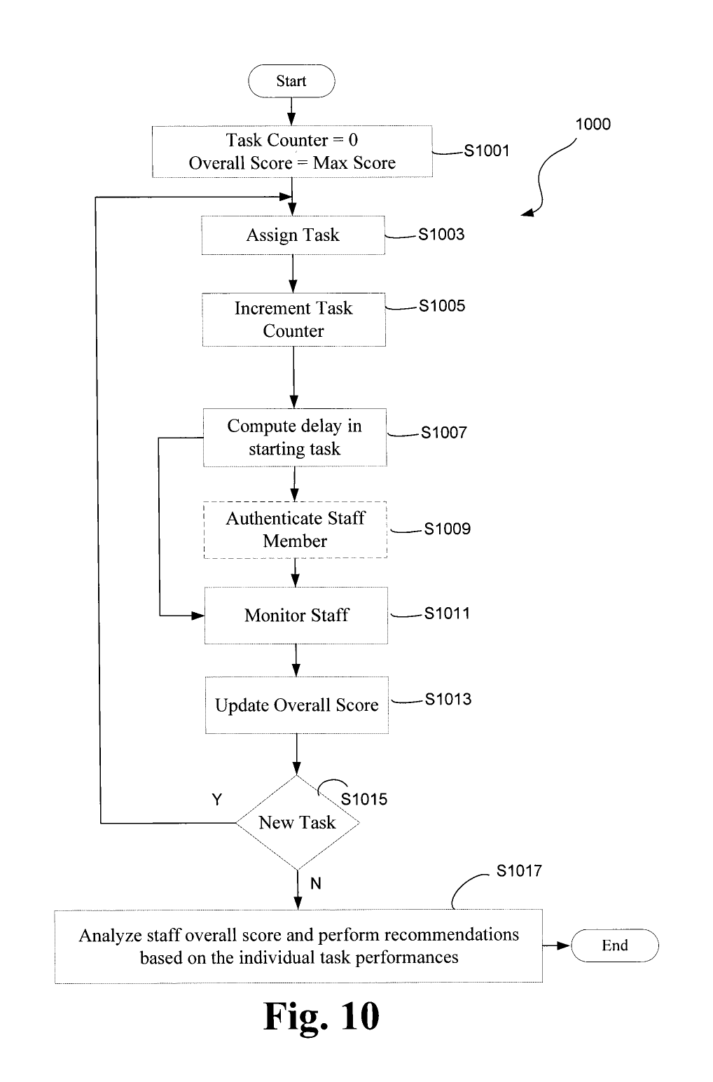

FIG. 2 illustrates a schematic block diagram of an exemplary mobile phone terminal device 200. The hardware components as depicted in FIG. 2 may be configured to perform the processing functions described later with reference to FIG. 10. As shown in FIG. 2, the mobile phone terminal device 200 may include an antenna 201 and a wireless communication processing section 202. The wireless communication processing section 202 may communicate wirelessly via radio signals, or the like, with other mobile devices via a base station. Additionally, as depicted in FIG. 1, the mobile phone terminal 200 may communicate with the server 101 via the network 104. Further, a data signal, such as a voice transmission from another user, may be received by antenna 201 and sent to the wireless communication processing section 202 for further processing. In the case of an incoming voice transmission, the voice data signal may be sent from the wireless communication processing section 202 to a voice processing section 203. Incoming voice data received by the voice processing section 203 via the wireless communication processing section 202 may be output as sound via a speaker 204.

Conversely, an outgoing voice signal may be supplied by a user to the voice processing section 203 via a microphone 205. The voice signal received via microphone 205 and processed by the voice processing section 203 may be sent to wireless communication processing section 202 for transmission by the antenna 201. The voice processing section 203 comprises a digital signal processor (DSP) 203a which digitizes the incoming analog signal and processes the audio input to detect for keywords. Keywords enable the operation of device 200, when it is configured to operate under the instructions of specific voice commands. These keywords are preset in the device with the aid of a voice registration unit and stored in the voice pattern library 203b.

A second antenna 206 may be supplied for use with a short distance wireless communication processing section 207. The short distance wireless communication processing section 207 may communicate wirelessly with other devices over a network, such as the Internet, a local area network (LAN), or a wide area network (WAN). The second antenna 206 may, e.g., by a Wi-Fi or a Bluetooth transceiver.

A sensor section 208 may be provided for the mobile phone terminal device 200. The sensor section 208 may be a motion sensor that detects a motion of an object in the proximity of the mobile phone terminal device 200. The motion may correspond to a user moving an instruction object, such as a finger or stylus, in the proximity of the mobile phone terminal device 200 for the purpose of selecting data displayed on display 220. Additionally, instructions transmitted from the sever 101 (FIG. 1) may be displayed on the display panel 220 of the mobile phone terminal 200. The sensor section 208 may include a GPS tracker that enables the location of the mobile device 200 to be determined and monitored by the server 101 of FIG. 1. Furthermore, the mobile phone terminal device 200 may include a camera 209 that is configured to acquire and display captured images and/or video on the display 220 of the mobile device 200.

The display 220 may be, for example a liquid crystal display (LCD) panel, an organic electroluminescent (OLED) display panel, a plasma display panel, or the like. The display 220 may display text, an image, a web page, a video, or the like. For example, when the mobile phone terminal device 200 connects with the Internet, the display 220 may display text and/or image data which is transmitted from a web server in Hyper Text Markup Language (HTML) format and displayed via a web browser. The display 220 may additionally display data stored in a memory 250.

A touch panel section 230 can detect a touch operation on the surface of the display 220. For example the touch panel 230 can detect a touch operation performed by an instruction object such as a finger or stylus. Touch operations may correspond to user inputs such as a selection of an icon or a character string displayed on the display 220. The touch panel section 230 may be an electrostatic capacitance type device, a resistive type touch panel device, or other such type devices for detecting a touch on a display panel.

The touch panel section 230 may perform processing related to touch operation classification. For example, the touch panel section 230 may assign a predetermined function to be performed when a “tap” touch operation is detected. Similarly, the touch panel section may analyze a touch operation in which the instruction object makes continuous contact with the display 220, while moving the instruction object around the display 220 (e.g., a “swipe” operation). The touch panel section 230 may output a signal based on a classification of the touch operation performed. The signal may for example, include information indicating the touch operation classification, the location on the display 220 where the touch operation was performed, and the operation to be performed based on the touch operation.

Data which is detected and processed by the touch panel 230 can be transmitted to a host controller 210. The host controller/processor 210 (processing circuitry) may include one or more processor units (circuits) and can control each element of the mobile phone terminal device 200 based on data detected by the touch panel 230, or by inputs received from operation key 240. The operation key 240 may receive inputs, e.g., from external control buttons included with the mobile phone terminal device 200. The external control buttons may for example control the volume, the power, or a hold operation for the mobile phone terminal device 200.

The host controller 210 may further execute instructions stored in the memory 250. The controller may further comprise of a DSP driver 211, which is configured to communicate with the DSP 203a. Specifically, the driver may actuate the DSP during a voice registering phase, or the DSP 203a may initiate communication with the driver upon the successful detection of a voice command. The driver 211 may further activate the host processor to execute a certain application based on the received voice commands. To this end, the memory 250 may be a non-transitory computer readable medium having instructions stored therein for controlling the mobile phone terminal device 200. Further, the controller 210 may include one or more processors for executing the instructions stored on the memory 250.

The mobile phone terminal device 200 can include a control line CL and a data line DL as internal bus lines for communication. The control line CL can be used to transmit control data from the controller 210. The data line DL may be used for the transmission of voice data, display data, or the like, throughout the various elements of the mobile phone terminal device 200.

FIG. 3A depicts, according to an embodiment, an exemplary wrist band 300 worn by a patient in the congregate care facility.

The wrist-band 300 includes an inner surface 310 (located proximate to a user's wrist, when the wrist-band 300 is worn) and an outer surface 320, in which a display 330 is embedded or otherwise located such that the display is visible to the user when the wrist-band 300 is worn. The wrist-band 300 can be utilized, for instance, to extend the functionality of a personal electronic device. For example, the wristband 300 may wirelessly communicate with a mobile phone or other electronic device using Bluetooth, Near Field Communication (NFC), or other means of wireless communication. Alternatively, the wristband 300 may be a stand-alone device that provides some or all of the functionality described herein, independent of whether the wrist-band 300 is actively communicating with a personal electronic device.

The display 330 of the multi-function wrist-band may be, for example a liquid crystal display (LCD) panel, an organic electroluminescent (OLED) display panel, a plasma display panel, or the like. The display 330 may display text, an image, a web page, a video, or the like. For example, when the wristband 300 connects with the Internet, the display 330 may display text and/or image data, which is transmitted from a web server in Hyper Text Markup Language (HTML) format and displayed via a web browser. The display 330 may additionally display data stored in a memory module that is included in the wrist-band 300. Furthermore, the display 330 may be configured to display the name of a staff member that has been assigned to supervise and assist the patient with a particular task.

Further, the wrist-band 300 includes a transceiver 340 that enables the wrist-band to communicate with the server 101 as described in FIG. 1. Specifically, the transceiver 340 includes a receiver portion and a transmitter portion, with some circuitry that may be shared between the receiver and transmitter portions, respectively. In the receiver portion of the transceiver 340, signals may be received on an antenna and processed through a front end that includes a filter and low noise amplifier circuitry. According to an embodiment, the transceiver 340 may be configured to communicate using the GSM 900 (Global System for Mobile) frequency band (925-960 MHz), or the DCS 1800 (Digital Cellular System) frequency band of 1805 to 1880 MHz. However, it must be appreciated that the transceiver 340 may be used with different combinations of frequency bands.

The wrist-band 300 includes radio frequency identification (RFID) tag 350. Each RFID tag is unique and can be used to identify the staff member or patient wearing the wrist-band. According to an embodiment, the RFID tag may be a surface acoustic wave (SAW) RFID tag that is made of materials that have piezoelectric characteristics. The RFID tag 350 may include a dipole antenna that is configured to communicate with a reader by transmission/reception of electromagnetic radio frequency signals. Accordingly, the RFID tag 350 on the wrist-band 300 is used to authenticate the patient of the wrist-band 300.

The wrist band 300 further includes two push buttons 360a and 360b that the patient (and/or staff member) can utilize to report the performance of the activity performed by the staff member to the server 101. According to one embodiment, the push button 360a can be utilized to report an acceptable level of performance by the staff member, whereas push button 360b can be used to indicate an unacceptable level of performance by the staff member. For instance, if the staff member reported late for performing a certain task, thereby causing inconvenience to the patient, the patient may utilize the 360b push button to report such an activity of the staff member to the server 101. In contrast, if the patient is satisfied with the level of the performance of the staff member, the patient could utilize push button 360a to indicate the satisfactory performance of the staff member to the server 101. The staff member may also use the 360b pushbutton to signal for prompt assistance should the circumstance require.

It must be appreciated that the level of satisfaction of the patient is dependent not only on the timeliness of the staff member in starting the task, but may be based on several factors such as personality, mannerisms, diligence and the like of the staff member performing the task. Furthermore, by one embodiment, it must be appreciated that the functionality of the push buttons 360a and 360b may be achieved by displaying two corresponding icons on the display panel 330 of the wrist band 300.

The wristband 300 may be made from a fireproof, unbreakable, and/or waterproof material. The wristband includes a processor (e.g., microcontroller) operatively coupled to a memory, a Global Positioning System (GPS) chipset and antenna to transmit and receive signals from the server 101, a battery and a back-up power module (e.g., solar cells) The processor may communicate with a display controller, RFID controller, and transceiver controller, by transmitting control signals to operate/control the functioning of the display, RFID tag, antennas and the like.

The battery provides primary operational power to the wristband, including the processor and the GPS chipset. The back-up power module provides secondary operational power to the wrist-band. The battery provides enough power to operate the wrist-band for several hours. The memory included in the wristband 300 includes a driver/program module and programmed data module. The program module includes computer-program instructions executable by the processor to implement features of the wristband. The program data module may be configured to store information pertaining to the wristband such as the unique RFID tag information, transmission data related to, for instance longitude and latitude coordinates of the location of the wristband and the like.

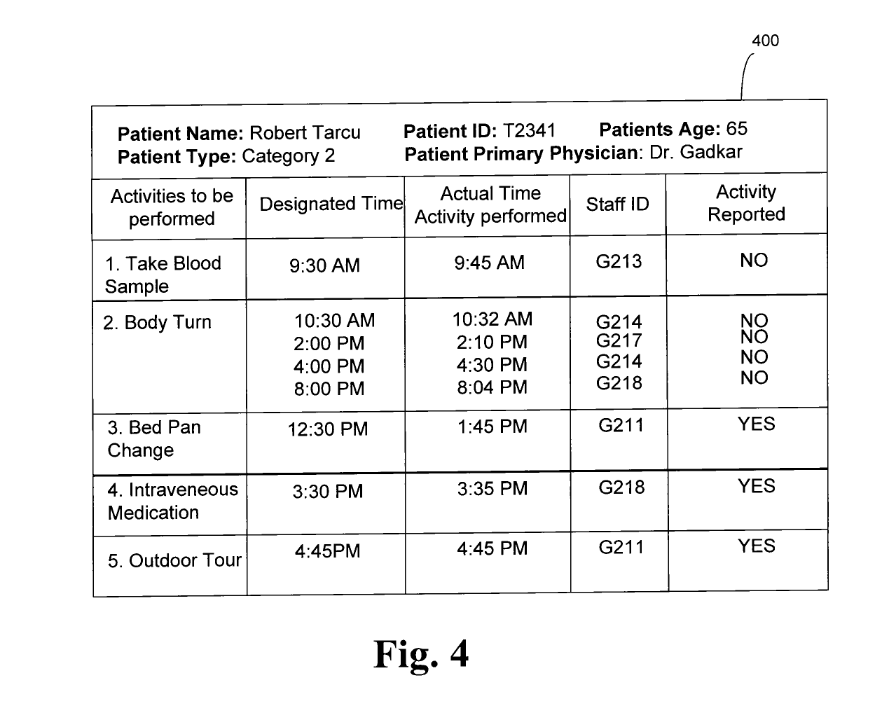

FIG. 4 illustrates according to one embodiment, an exemplary patient chart 400. The patient chart 400 includes information such as the patient's name, patient's ID, patients age, patient's primary care physician, and patient's type. As shown in FIG. 4, the type of patient can be categorized into one of a plurality of categories as explained later with reference to FIG. 6A.

Additionally, the patient chart 400 outlines activities along with a designated time to perform the activity, as recommended by the primary care physician. The activities may include a bed pan change, obtaining a blood sample, taking the patient for an outdoor tour and the like. Such activities are to be performed by the staff members that are assigned the particular activity. The server 101 monitors the actual start time a particular staff member commenced a certain activity. By one embodiment, the server 101 determines the start time of each activity by monitoring the GPS location signals obtained from the mobile device 106 of the staff member and the GPS signals obtained from the corresponding patient's wristband. By comparing a time-stamp transmitted from the mobile device of the staff member and the wristband of the patient to a central clock (included in the server), the server computes whether there is a delay in commencing the assigned activity.

Alternatively, the staff member 105 may perform a touch operation on the mobile device 106 to indicate the commencement of a particular activity to the server 101. The server 101 upon receiving such information may determine the location of the staff member (via GPS signals) to authenticate the commencement of the particular activity. Furthermore, the server may utilize additional processes (as described later with reference to FIG. 10) to authenticate the commencement and/or completion of the assigned activities.

Furthermore, as shown in FIG. 4, the patient chart 400 also includes Staff ID information listing the identification number of a staff member performing the activity. Additionally, for each activity, the server maintains a record of whether or not the activity is reported. As stated previously, the activity performed by the staff member may be reported by the patient based on a delay in commencement of the activity as well as factors such as the staff member's mannerisms, personality and the like. The information pertaining to whether an activity is reported is utilized by the server in determining a performance score for each staff member as described later with reference to FIG. 10.

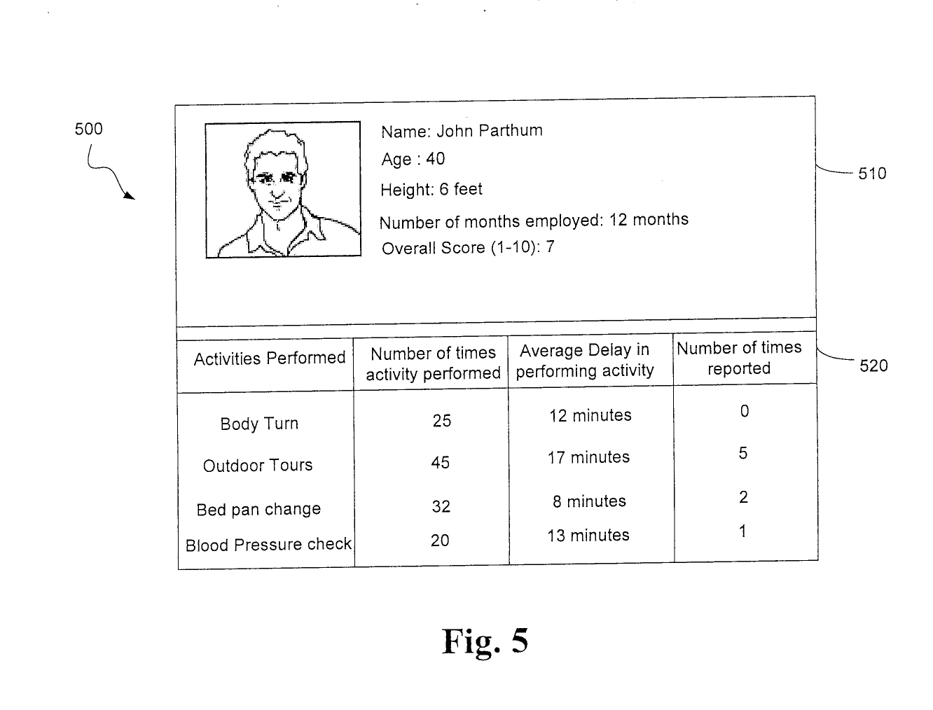

FIG. 5 illustrates an exemplary staff member report 500. The report 500 includes a staff member profile portion 510 and an activity portion 520. The profile portion 510 contains summary information including a picture of the staff member and information such as name, age, height, number of months the staff member has been employed and an overall score (OS) of the staff member.

The activity portion 520 includes a list of activities performed by the staff member, number of times a certain activity was performed, an average delay in starting a particular activity, and number of times the staff member has been reported for a certain activity. The information included in the activity portion 520 of the report 500 is used to compute the OS of the staff member. It must be appreciated that the report 500 as illustrated in FIG. 5 is only an exemplary example and may include other information pertinent to the staff member such as identities of patients assisted, a work schedule of the staff member, amount of time spent performing the activities, amount of time utilized in breaks and the like.

Turning to FIG. 6A is depicted according to one embodiment, a table outlining the types of patients in the congregate care facility. As shown in FIG. 6A, a particular patient may be categorized into one of three categories based on a medical condition of the patient and amount of assistance required by the patient for the activities recommended by the patient's primary care physician. Specifically, a patient who suffers from a serious medical condition may be categorized as a category-I patient. Such patients usually require constant monitoring and assistance from the staff members. Accordingly, such patients may have a small time threshold that the patient may be willing to wait for the staff member to commence a particular activity. For instance, as shown in FIG. 6A, the patients of category I may have a time threshold of five minutes. By one embodiment, if the staff member does not commence a particular activity associated with such a patient within the time threshold, the staff member is reported on the activity by the patient. Furthermore, for the patients of category I, another embodiment of the system is a triaged alert to supervisors or other staff that the scheduled activity has not commenced within the time threshold, calling for communications or other direct care interventions.

In a similar manner, patients who have medium and substantially less severe medical conditions may be categorized as category-II and category-III patients, respectively. As shown in FIG. 6A, the time thresholds corresponding to these categories may be fifteen and twenty minutes respectively, which are higher than the time threshold for a category-I patient. Further, it must be appreciated that the number of categories of patients as well the corresponding thresholds for the categories are in no way limited to those as shown in FIG. 6A. A congregate care facility may incorporate within their system any number of categories with predetermined time thresholds for each category. Additionally, each of the patients in the congregate care facility may have a unique time threshold assigned to the patient based on the medical condition and requirements of the patient.

FIG. 6B depicts a table outlining the types of activities performed by the staff members. The various activities performed by staff members in the congregate care facility may be categorized based on whether the activity is a patient related activity or an administrative activity. For instance, as shown in FIG. 6B, the activities pertaining to patients can be categorized as either a type-I or a type-II activity based on a location where the activity is performed, whereas activities pertaining to administrative duties can be categorized as a type-III activity. It must be appreciated that the types of activities as depicted in FIG. 6B is only illustrative, and a congregate care facility may have more activities that can be categorized into more than three types.

FIG. 7 depicts according to one embodiment a layout 700 of a congregate care facility. The congregate care facility as depicted in FIG. 7 includes a break area room 701, a medical supply room 703, a common room 705, an administration area 707, a dining area 709, a patient room 711, a therapy room 713, and an outdoor facility area 715. Further, each of the above areas may be interconnected by corridors and/or separated from each other by walls.

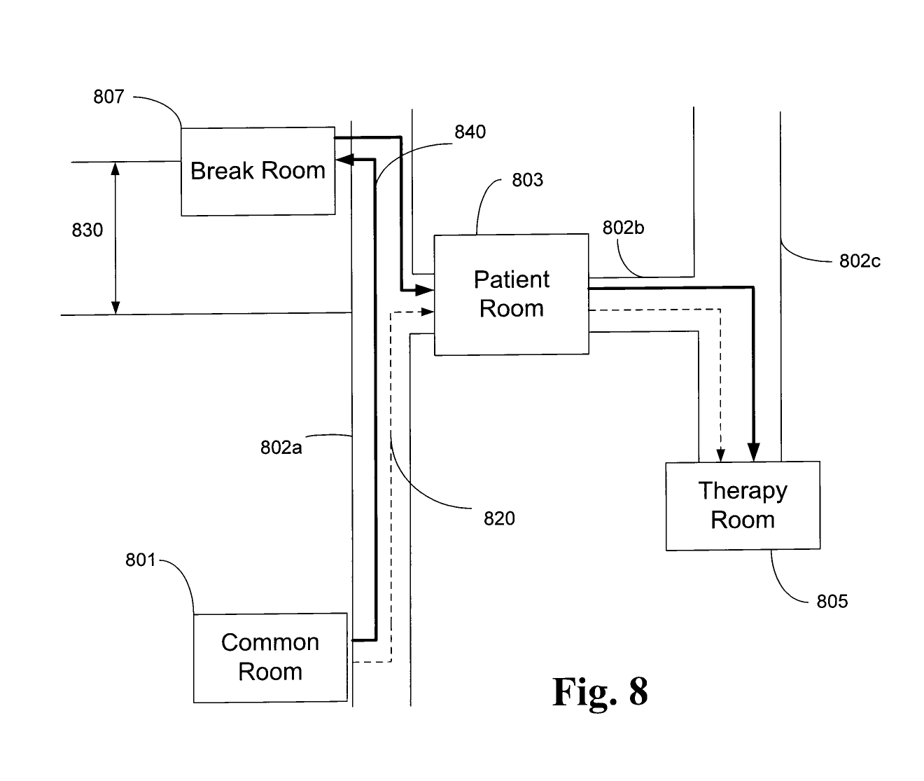

As shown in FIG. 7, the legend 750 illustrates the pathways leading to a particular area that are accessible by staff members 790 and patients, respectively. Specifically, the bold lines depict the pathways that may be taken by the staff member 790, whereas the dashed lines correspond to the pathways that may be taken by patients. As illustrated in FIG. 7, the staff member 790 has access to all areas of the medical facility, whereas the patients are restricted to have access only to the common room 705, patient room 711, dining area 709, therapy area 713 and outdoor facility 715. By one embodiment, a staff member may be assigned an activity to transport a patient from one area to another. As described next with reference to FIG. 8, while performing such an activity, the server 101 may monitor the location of the staff member and the location of the corresponding patient that is being transported, in order to determine whether the staff member is performing the activity in an acceptable manner.

FIG. 8 depicts an exemplary portion of the layout of the congregate care facility. Specifically, FIG. 8 depicts a common room 801 and a patient room 803 that are connected by a corridor 802a. The corridor 802a further connects the patient room 803 to a break room 807. The patient room 803 is connected via corridor 802b and 802c to a therapy room 805.

According to one embodiment, a staff member may be assigned an activity of transporting a patient from the common room 801 to the therapy room 805. A patient may traverse a path through corridor 802a from the common room 801 to the patient room 803 and further use corridors 802b and 802c to traverse from the patient room 803 to eventually reach the therapy room 805. The path traversed by the patient is depicted in FIG. 8 by the dotted line 820.

Furthermore, it is anticipated that the staff member assisting the patient to traverse from the common room 801 to the therapy room 805 utilizes the same path as the patient. However, the staff member may potentially leave the patient un-attended for a certain span of time and rather traverse from the common room 801 to the break room 807 and finally rejoin the patient at the patient room 803 to eventually transfer the patient to the therapy room 805. The path traversed by the staff member is depicted in FIG. 8 by the bold lines 840. The occurrence of such an event of leaving the patient un-attended may be against the policies of the congregate care facility.

Accordingly, the server 101 as described in FIG. 1 continuously monitors the location of the patient and the location of the staff member assisting the patient, via GPS signals transmitted from the mobile device and the wristband, respectively. By one embodiment, the server is further configured to compute a magnitude of deviation (represented as 830 in FIG. 8) between the paths traversed by the staff member and the patient. Upon the computed deviation being above a predetermined distance threshold, the staff member is penalized for his actions. Specifically, staff member's overall score is reduced by a certain amount (described later with reference to FIG. 10), for each time the staff member does not adhere to the operational policies of the congregate care facility.

Additionally, by one embodiment, the server may keep a track of time the staff member has kept the patient unattended. If the amount of unattended time exceeds a certain time threshold, the server may penalize the overall score of the staff member. Furthermore, the patient may report the activity of the staff member based on at least one of the start time of the activity exceeding a predetermined threshold and an amount of time the staff member keeps the patient unattended.

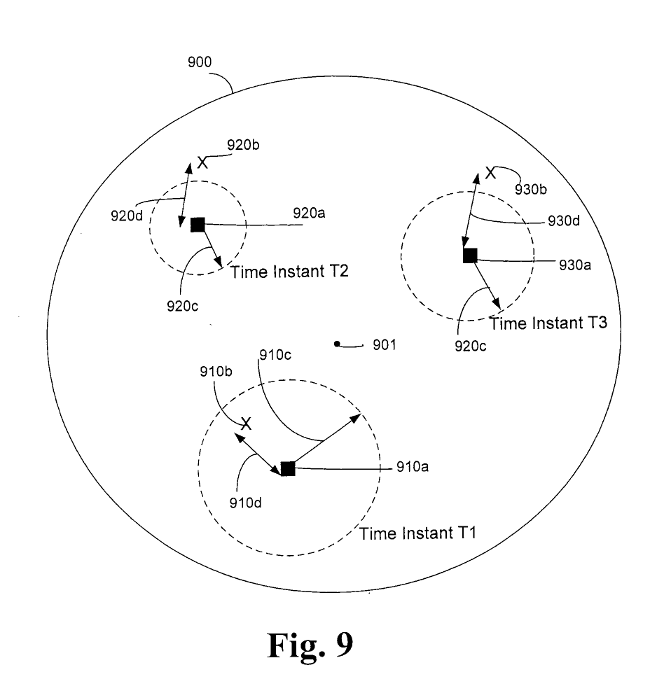

FIG. 9 illustrates an exemplary server monitoring scenario according to one embodiment of the present disclosure. Consider the case wherein the activity assigned to the staff member is one of taking a patient for an outdoor facility visit (Activity type-II as illustrated in FIG. 6B).

As shown in FIG. 9, the geographical region corresponding to the outdoor facility is represented as a circular region 900 having a center represented as 901. Further, the location of the patient (that is detected via GPS signals transmitted by the wristband of the patient) at three distinct time instances is depicted by squares 910a, 920a, and 930a, respectively. Similarly, the locations of the staff member at the three distinct time instances is depicted by the marks ‘X’, represented as 910b, 920b, and 930b, respectively. Based on the detected positions of the patient and the staff member, the server computes a displacement of the detected location of the staff member with respect to the detected location of the patient. Specifically, as shown in FIG. 9, the displacements at the three distinct time instances is represented as 910d, 920d, and 930d, respectively.

By one embodiment, the server continuously monitors the locations of the patient and the staff member. Further, the server determines whether the computed displacement between the detected positions is greater than a predetermined threshold. Specifically, consider the first time instance (T1) having the detected position of the patient being represented as 910a and the detected position of the staff member being represented as 910b. The server determines whether the computed displacement 910d is greater than a predetermined distance threshold represented as 910c. In other words, at each time instant, the server determines whether the staff member is located within a predetermined area centered at the detected location of the patient, wherein the predetermined area has a radius that is equal to the threshold distance. Similarly, as time instances T2 and T3, the server determines whether the computed displacements 920d and 930d respectively, are greater than the predetermined distance thresholds 920c and 930c, respectively.

It must be appreciated that the server may employ different distance thresholds at different time instances upon being instructed by the patient to do so. In contrast, the server may employ the same distance thresholds for all time instances. By one embodiment, the patient may determine the distance threshold based on the location within the geographical region 900. Alternatively, or in addition, the patient may determine the distance threshold based on a number of other staff members and/or patients in the vicinity of the patients. For instance, if there are other staff members and/or patients located in the vicinity of the patient, a larger distance threshold may be set by the patient, as if immediate assistance is required and the assigned staff member is not within an accessible distance, the patient can rely on the other staff members for help. In contrast, is the number of other staff members and/or patients in the vicinity of the patient is low, the patient may set a smaller distance threshold.

As shown in FIG. 9, the server monitors the position of the staff member and determines a number of times the staff member is displaced greater (time instances T2 and T3) than the distance threshold from the location of the patient. Further, the server may penalize the overall score of the staff member based on the determined number of times the staff member is located farther than the distance threshold from the patient. In addition, by one embodiment, the patient and/or server may determine an amount of time the staff member is displaced farther than the distance threshold, and accordingly, either the patient may report the activity to the server and/or the server may penalize the overall score of the patient. Thus, the overall score of the staff member may be affected by either the patient reporting the activity and/or the server directly penalizing the patient.

FIG. 10 depicts an exemplary flowchart outlining the steps performed by the server according to one embodiment. The process depicted in FIG. 10 commences at step S1001, wherein the server initializes a task counter to zero and sets the overall score (OS) of the staff member to a maximum score. The task counter is a parameter that tracks the number of tasks performed by the staff member. The maximum score may be a predetermined highest score that a staff member can achieve. For instance, if the staff members are evaluated on a scale of 0-10 (with 10 being the highest score), the maximum score parameter may be set to have a value of 10.

In step S1003, the server assigns a task (i.e., an activity to be performed) to the staff member, and thereafter in step S1005 increments the value of the task counter by one.

Next, the process proceeds to step S1007 and computes an amount of time delay incurred by the staff member in commencing the assigned task. By one embodiment, the server monitors the location of the staff member with respect to a first location where the staff member is expected to be in order to commence the activity (i.e., the first location corresponds to a location in the vicinity of the patient). Further, the server compares a detected time instance (corresponding to the time instance when the staff member is detected near the patient) to a prescribed time (by the primary care physician) that corresponds to the time the activity is supposed to be performed. In such a manner, the server computes a delay incurred by the staff member in commencing the activity.

Upon computing the delay incurred in commencing the activity assigned to the staff member (step S1007), the process may either proceed to step S1009 or step S1011. Specifically, the process may proceed to step S1009 and authenticate the staff member performing the activity. The process of authenticating the staff member in step S1009 provides an extra layer of inspection, in order to determine that the assigned staff member is infact performing the assigned activity and thereby no fraudulent activity is incurred.

According to an embodiment, the server may determine to proceed from step S1007 to step S1009 (instead of step S1011) based on the overall score (computed up to the instant of time the current task is assigned to the staff member) and a predetermined score threshold to determine whether the authentication process is to be initiated. For instance, if the overall score of the patient is lower than the predetermined threshold score, the server may initiate the authentication process. By one embodiment, the server may also initiate the authentication process based on the staff member being previously reported for the activity under consideration. The authentication process may include the server transmitting a series of instructions to the mobile device of the staff member. For instance, the server may instruct the staff member to take an image of the staff member. The server may crosscheck a time stamp on the image received from the staff member as well as compare the received image to a central repository of images of staff members to authenticate the staff member. Additionally, the server may instruct the staff member to obtain an image of the staff member along with the patient being assisted, record via the mobile device the activity of the staff member while assisting the patient and the like.

The process in step S1011 monitors the location of the staff member and the patient. For instance, as described previously with respect to FIG. 8 and FIG. 9, the server in step S1011 may continuously monitor the locations of the patient and the staff member to compute a displacement of the location of the staff member with respect to the location of the patient. Further, based on the computed displacement being greater than a distance threshold, the server may penalize the overall score of the staff member.

The process further proceeds to update the overall score of the staff member in step S1013. By one embodiment, the server may penalize the overall score of the staff member for: (a) a time delay of the staff member in commencing a particular assigned activity, (b) a displacement of the detected position of the staff member with respect to the detected position of the patient being greater than the distance threshold, and (c) an amount of time the staff member's detected location is greater than a neighbourhood threshold from the detected location of the patient.

Referring to FIG. 9, the distance threshold may correspond to the radius of the circular region centered around the location of the patient (for example radius 920c of the circular region at time instant T2). Specifically, if the detected location of the staff member is greater that the distance threshold (i.e., the staff member is located outside the circular region) the server may penalize the overall score of the staff member. However, in certain instances, the staff member may be located within the circular region (as shown in FIG. 9 at time instant T1), but may not be located close enough to the patient's detected location in order to provide immediate assistance if required. In such instances, the server may monitor the amount of time the detected location of the staff member with respect to the patient's location is greater than a neighbourhood threshold (which is less than the distance threshold), and accordingly penalize the staff member's overall score.

Accordingly, the server in step S1013 updates the overall score (OS) of the staff member as follows:

OS=MaxScore−[αⱼdⱼ+βⱼtⱼ+γⱼDⱼ],

where the parameter dᵢ corresponds to the time delay incurred by the staff member in commencing activity j, the parameter tⱼ corresponds to the amount of time the staff member's detected location is greater than the neighbourhood threshold while performing activity j, and the parameter Dⱼ corresponds to the amount of displacement (greater than the distance threshold) that the location of the staff member is disposed from the location of the patient. Further, the parameters αⱼ, βⱼ, and γⱼ correspond to predetermined scaling factors.

In step S1015, a query is made to determine whether a new task is to be assigned to the staff member. If the response is affirmative the process loops back to step S1003 to repeat the process. On the other hand, if there are no more new tasks to be assigned to the staff member, the process proceeds to step S1017.

In step S1017, the server computes the overall updated score of the staff member. The overall updated score of the staff member upon completion of N tasks can be computed as follows:

$$OS = MaxScore - [ {\sum }_{j = 1}^{j = N} {α}_{j} {d}_{j} + {\sum }_{j = 1}^{j = N} {β}_{j} {t}_{j} + {\sum }_{j = 1}^{j = N} {γ}_{j} {D}_{j} ] ,$$

Upon computing the overall score of the staff member, the server by one embodiment, determines whether the staff member is required to undergo a training session. For instance, if the overall score of the staff member is lower than a predetermined threshold score, the server analyzes for example, the number of times the staff member was reported by the patients. The server may further determine whether the staff member has been reported for a particular activity more than a predetermined number of times. The server may further recommend a training session for the staff member, wherein the cause of the staff member being reported can be addressed.

For instance, if the staff member is reported by patients for not having a pleasing personality, the server may recommend some behavioral lessons for the staff member. On the other hand, if the staff member is reported for leaving the patient unassisted for a certain amount of time, the server may recommend an alternate training session for the staff member. It must be appreciated that the server may be configured to recommend other training sessions (for the different activities performed) to the staff member based on the score of staff member being less than a predetermined threshold score. Additionally, the server may be configured to reset the overall score of the patient after a predetermined amount of time, for example, the server may perform the steps depicted in the flowchart of FIG. 10 every month, every week and the like. Upon recommending the training sessions, the process as depicted in FIG. 10 terminates.

Further, it must appreciated that the server 101 may perform additional tasks to ensure that the activities assigned to the staff members are performed in a timely and efficient manner. For instance, by one embodiment, the server assigns a set of tasks (a master activity list) that are to be performed by a particular staff member within a predetermined time period e.g., a day. As stated previously, the server further monitors the activities performed by the staff member. Upon monitoring the staff member, if it is established that the staff member is taking a greater time than an allocated amount of time to perform the task, the server updates the staff member's master duty list. For instance, consider that a staff member is assigned a task of bathing patient ‘x’ at 10:30 a.m. and obtaining a blood sample for patient ‘y’ at 11:15 a.m. Further, consider that the allocated patient rooms for patient ‘x’ and patient ‘y’ are located far away from each other, wherein a staff member would require at least 10 minutes traversing from patient x's room to patient y's room.

In such a scenario, if the server determines for instance, that the staff member at 11:10 a.m. is still performing the bathing activity for patient ‘x’, the server updates the activity list of the staff member. Specifically, the staff member's next activity (obtaining the blood sample of patient ‘y’) is removed from the staff member's master list, as the sever determines that the staff member will incur a delay in commencing the next activity. The server may assign the next activity to another staff member based on his/her location and availability.

Additionally, by one embodiment, the server may incorporate the feature of determining the number of activities removed (i.e., updated) from a particular staff members activity list, while analyzing the performance of the staff member (as described in step S1017 of FIG. 10). The server may penalize the overall score of the staff member and/or notify the staff member's supervisor based on the number of updated activities from the staff member's duty list exceeding a predetermined threshold. In doing so, the server provides a mechanism wherein the supervisor may consult with the staff member to determine the reason(s) for the staff member taking more than the allocated time for performing the task.

By one embodiment, while monitoring the staff member's activity corresponding to a particular patient, the server tracks the location of the patient as well as the staff member via the GPS signals as described previously. The server may further cross check the identity of the staff member and the patient (via lookup into a central database) to ensure that the staff member is assisting the correct patient. If the server determines that a staff member is assisting (or is about to commence assisting) an incorrect patient, the server may transmit a warning message on the mobile device of the staff member, the wristband of the patient, as well as inform the staff member's supervisor. Such a technique can also be utilized by the server to monitor whether a patient traverses by himself/herself in a restricted area. For instance, referring to FIG. 7, if the server determines that a particular patient is detected (via the GPS signals transmitted by patient's wristband) in a restricted area for patients such as the administration area 707, the server may transmit an alert message to the mobile device of a supervisor, thereby notifying the supervisor of the occurrence of the event.

Furthermore, the embodiments described above are in no manner limiting the scope of the present disclosure. Other equivalent techniques of performing the functionalities of the above described embodiments are well within the scope of the present disclosure. For instance, the server may monitor and track the locations of the staff members and patients via a WiFi network of the congregate care facility. Additionally, devices such as Apple watch, Fit Bit, or any other exercise bands that have Bluetooth, and/or WiFi capabilities can be used to track the patients and/or staff members.

Additionally, by one embodiment, the patients as well as staff members in the congregate care facility may be equipped with RFID chips that may be embedded within the badges worn by the staff members and the medical bracelets (wristbands) worn by the patients. Thus, the server may detect and monitor the movement of the patients as well as the staff members based on RFID detection techniques. In addition, the monitoring techniques described herein may be implemented as a safety mechanism to ensure that unauthorized personnel, intruders or the like do not have access to the medical facility. The server may crosscheck the RFID signals, GPS signals, and the like against local sensors such as floor sensors, motion sensors and the like embedded within the facility to authenticate the individual(s) located within the facility.

Each of the functions of the described embodiments may be implemented by one or more processing circuits. A processing circuit includes a programmed processor (for example, processor 1103 in FIG. 11), as a processor includes circuitry. A processing circuit also includes devices such as an application-specific integrated circuit (ASIC) and circuit components arranged to perform the recited functions.

The various features discussed above may be implemented by a computer system (or programmable logic). FIG. 11 illustrates such a computer system 1101. As noted above, each of the devices 101, 106, 107, 108, and 300 may have a configuration as shown in FIG. 11. In one embodiment, the computer system 1101 is a particular, special-purpose machine when the processor 1103 is programmed to perform monitoring, authentication and evaluation processes.

The computer system 1101 includes a disk controller 1106 coupled to the bus 1102 to control one or more storage devices for storing information and instructions, such as a magnetic hard disk 1107, and a removable media drive 1108 (e.g., floppy disk drive, read-only compact disc drive, read/write compact disc drive, compact disc jukebox, tape drive, and removable magneto-optical drive). The storage devices may be added to the computer system 1101 using an appropriate device interface (e.g., small computer system interface (SCSI), integrated device electronics (IDE), enhanced-IDE (E-IDE), direct memory access (DMA), or ultra-DMA).

The computer system 1101 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1101 may also include a display controller 1109 coupled to the bus 1102 to control a display 1110, for displaying information to a computer user. The computer system includes input devices, such as a keyboard 1111 and a pointing device 1112, for interacting with a computer user and providing information to the processor 1103. The pointing device 1112, for example, may be a mouse, a trackball, a finger for a touch screen sensor, or a pointing stick for communicating direction information and command selections to the processor 1103 and for controlling cursor movement on the display 1110.

The processor 1103 executes one or more sequences of one or more instructions contained in a memory, such as the main memory 1104. Such instructions may be read into the main memory 1104 from another computer readable medium, such as a hard disk 1107 or a removable media drive 1108. One or more processors in a multi-processing arrangement may also be employed to execute the sequences of instructions contained in main memory 1104. In alternative embodiments, hard-wired circuitry may be used in place of or in combination with software instructions. Thus, embodiments are not limited to any specific combination of hardware circuitry and software.

As stated above, the computer system 1101 includes at least one computer readable medium or memory for holding instructions programmed according to any of the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable media, the present disclosure includes software for controlling the computer system 1101, for driving a device or devices for implementing the invention, and for enabling the computer system 1101 to interact with a human user. Such software may include, but is not limited to, device drivers, operating systems, and applications software. Such computer readable media further includes the computer program product of the present disclosure for performing all or a portion (if processing is distributed) of the processing performed in implementing any portion of the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any non-transitory medium that participates in providing instructions to the processor 1103 for execution. A computer readable medium may take many forms, including but not limited to, non-volatile media or volatile media. Non-volatile media includes, for example, optical, magnetic disks, and magneto-optical disks, such as the hard disk 1107 or the removable media drive 1108. Volatile media includes dynamic memory, such as the main memory 1104. Transmission media, on the contrary, includes coaxial cables, copper wire and fiber optics, including the wires that make up the bus 1102. Transmission media also may also take the form of acoustic or light waves, such as those generated during radio wave and infrared data communications.

Various forms of computer readable media may be involved in carrying out one or more sequences of one or more instructions to processor 1103 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 1101 may receive the data on the telephone line and place the data on the bus 1102. The bus 1102 carries the data to the main memory 1104, from which the processor 1103 retrieves and executes the instructions. The instructions received by the main memory 1104 may optionally be stored on storage device 1107 or 1108 either before or after execution by processor 1103.

The computer system 1101 also includes a communication interface 1113 coupled to the bus 1102. The communication interface 1113 provides a two-way data communication coupling to a network link 1114 that is connected to, for example, a local area network (LAN) 1115, or to another communications network 1116 such as the Internet. For example, the communication interface 1113 may be a network interface card to attach to any packet switched LAN. As another example, the communication interface 1113 may be an integrated services digital network (ISDN) card. Wireless links may also be implemented. In any such implementation, the communication interface 1113 sends and receives electrical, electromagnetic or optical signals that carry digital data streams representing various types of information.

The network link 1114 typically provides data communication through one or more networks to other data devices. For example, the network link 1114 may provide a connection to another computer through a local network 1115 (e.g., a LAN) or through equipment operated by a service provider, which provides communication services through a communications network 1116. The local network 1114 and the communications network 1116 use, for example, electrical, electromagnetic, or optical signals that carry digital data streams, and the associated physical layer (e.g., CAT 5 cable, coaxial cable, optical fiber, etc.). The signals through the various networks and the signals on the network link 1114 and through the communication interface 1113, which carry the digital data to and from the computer system 1101 may be implemented in baseband signals, or carrier wave based signals.

The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1101 can transmit and receive data, including program code, through the network(s) 1115 and 1116, the network link 1114 and the communication interface 1113. Moreover, the network link 1114 may provide a connection through a LAN 1115 to a mobile device 1117 such as a personal digital assistant (PDA) laptop computer, or cellular telephone. Specifically, the devices worn by the patients and the staff members may connect to the network using wireless, Bluetooth, WiFi and the like connectivity techniques.

While aspects of the present disclosure have been described in conjunction with the specific embodiments thereof that are proposed as examples, alternatives, modifications, and variations to the examples may be made. Furthermore, the above disclosure also encompasses the embodiments noted below. It should be noted that, as used in the specification and the appended claims, the singular forms “a,” “an,” and “the” include plural referents unless the context clearly dictates otherwise.

What is claimed is:

1. A device comprising:
circuitry configured to
assign a task to a staff member,
compute a time delay incurred by the staff member in commencing the task,
authenticate the staff member,
monitor a location of the staff member and a patient assisted by the staff member, to determine a displacement of the location of the staff member with respect to the location of the patient,
update an overall score of the staff member based on at least one of the computed time delay, the displacement of the location of the staff member with respect to the location of the patient being above a first threshold, and a number of times the staff member is reported,
recommend a type of training session for the staff member based on the overall score being lower than a predetermined score threshold,
collect and aggregate information and data regarding staff member and patient interactions, based on types of interactions and types of patients, and
enable supervisors and managers to generate reports documenting activities performed on behalf of specific patients, activities performed by specific staff members over specific time periods.
